(19) United States
(12) Patent Application Publication
(10) Pub. No.: US 2015/0195854 A1
(43) Pub. Date: Jul. 9, 2015

(54) METHODS AND APPARATUS FOR CONTENTION BASED TRANSMISSION

(71) Applicants: Jianchi Zhu, Beijing (CN); Zhi Zhang, Beijing (CN); Haipeng Lei, Beijing (CN); Kodo Shu, Shanghai (CN)

(72) Inventors: Jianchi Zhu, Beijing (CN); Zhi Zhang, Beijing (CN); Haipeng Lei, Beijing (CN); Kodo Shu, Shanghai (CN)

(73) Assignee: Nokia Corporation, Espoo (FI)

(21) Appl. No.: 14/410,636

(22) PCT Filed: Jul. 3, 2012
(86) PCT No.: PCT/CN2012/078125

§ 371 Date: Dec. 23, 2014

(51) Int. Cl. H04W 74/08; H04W 72/04

(52) U.S. Cl. CPC H04W 74/08; H04W 72/0413; H04W 72/042

(57) ABSTRACT

Systems and techniques for contention based transmission in a cellular network. A physical uplink shared channel is used for contention based transmission by a device such as a user equipment, based at least in part on information provided by a physical uplink control channel associated with the physical uplink shared channel. In addition, a base station such as an eNodeB may respond to a physical uplink shared channel by providing a common physical downlink shared channel providing acknowledge ment/negative acknowledgement information. In addition, the base station may provide a physical downlink control channel indicating the common physical downlink shared channel.

### TECHNICAL FIELD

The present invention relates generally to telecommunications. More particularly, the invention relates to systems and techniques for contention based transmission in cellular communication systems.

### BACKGROUND

One important application of wireless telecommunications is the provision of data services. In one commonly seen application, a single device providing a cellular network connection serves as a wireless network access point to a plurality of wireless network stations. A device, such as a user equipment (UE) operating in a cellular network such as a third generation preferred partnership long term evolution (3GPP-LTE) network may serve as a hotspot, that is, a device that provides access to data communication through a cellular network while at the same time allowing for wireless local area network access to devices within its vicinity. A single hotspot can serve multiple devices, with the device serving as the hotspot being the only device that needs to provide a cellular connection.

### SUMMARY

In one embodiment of the invention, an apparatus comprises at least one processor and memory storing computer program code. The computer program code is configured to, with the memory and the at least one processor, cause the apparatus to at least perform contention based transmission using a physical uplink shared channel, based at least in part on information provided by a physical uplink control channel associated with the physical uplink shared channel.

In another embodiment of the invention, an apparatus comprises at least one processor and memory storing computer program code. The computer program code is configured to, with the memory and the at least one processor, cause the apparatus to at least configure a physical uplink control channel providing information relating to contention based transmission by a user equipment in a cellular network, using a physical uplink shared channel.

In another embodiment of the invention, an apparatus comprises at least one processor and memory storing computer program code. The computer program code is configured to, with the memory and the at least one processor, cause the apparatus to at least attempt to decode a physical downlink shared channel to obtain acknowledgement/negative acknowledgement information associated with the apparatus, information relating to the physical downlink shared channel is available in a common physical downlink control channel and, upon successful decoding, determine, based at least in part on acknowledgement/negative acknowledgement information associated with the apparatus and provided by the physical downlink shared channel, whether to perform contention based transmission.

In another embodiment of the invention, an apparatus comprises at least one processor and memory storing computer program code. The computer program code is configured to, with the memory and the at least one processor, cause the apparatus to at least respond to a contention based physical uplink control channel by sending to at least one user equipment a common physical downlink control channel and a common physical downlink shared channel, wherein the physical downlink shared channel provides acknowledgement/negative acknowledgement information for multiple user equipments.

In another embodiment of the invention, a method comprises performing contention based transmission using a physical uplink shared channel, based at least in part on information provided by a physical uplink control channel associated with the physical uplink shared channel.

In another embodiment of the invention, a method comprises configuring a physical uplink control channel providing information relating to contention based transmission by a user equipment in a cellular network, using a physical uplink shared channel.

In another embodiment of the invention, a method comprises attempting to decode a physical downlink shared channel to obtain acknowledgement/negative acknowledgement information associated with the apparatus, information relating to the physical downlink shared channel is available in a common physical downlink control channel and, upon successful decoding, determining, based at least in part on acknowledgement/negative acknowledgement information associated with the apparatus and provided by the physical downlink shared channel, whether to perform contention based transmission.

In another embodiment of the invention, a method comprises responding to a contention based physical uplink control channel by sending to at least one user equipment a common physical downlink control channel and a common physical downlink shared channel, wherein the physical downlink shared channel provides acknowledgement/negative acknowledgement information for multiple user equipments.

In another embodiment of the invention, a computer readable medium stores a program of instructions, execution of which by a processor configures an apparatus to at least perform contention based transmission using a physical uplink shared channel, based at least in part on information provided by a physical uplink control channel associated with the physical uplink shared channel.

In another embodiment of the invention, a computer readable medium stores a program of instructions, execution of which by a processor configures an apparatus to at least configure a physical uplink control channel providing information relating to contention based transmission by a user equipment in a cellular network, using a physical uplink shared channel.

In another embodiment of the invention, a computer readable medium stores a program of instructions, execution of which by a processor configures an apparatus to at least attempt to decode a physical downlink shared channel to obtain acknowledgement/negative acknowledgement information associated with the apparatus, information relating to the physical downlink shared channel is available in a common physical downlink control channel and, upon successful decoding, determine, based at least in part on acknowledgement/negative acknowledgement information associated with the apparatus and provided by the physical downlink shared channel, whether to perform contention based transmission.

In another embodiment of the invention, a computer readable medium stores a program of instructions, execution of which by a processor configures an apparatus to at least respond to a contention based physical uplink control channel by sending to at least one user equipment a common physical downlink control channel and a common physical downlink shared channel, wherein the physical downlink shared channel provides acknowledgement/negative acknowledgement information for multiple user equipments.

In another embodiment of the invention, an apparatus comprises means for performing contention based transmission using a physical uplink shared channel, based at least in part on information provided by a physical uplink control channel associated with the physical uplink shared channel.

In another embodiment of the invention, an apparatus comprises means for configuring a physical uplink control channel providing information relating to contention based transmission by a user equipment in a cellular network, using a physical uplink shared channel.

In another embodiment of the invention, an apparatus comprises means for attempting to decode a physical downlink shared channel to obtain acknowledgement/negative acknowledgement information, wherein the obtained acknowledgement/negative acknowledgement information relating to the physical downlink shared channel is available in a common physical downlink control channel. The apparatus further comprises means for, upon successful decoding, determining, based at least in part on the acknowledgement/negative acknowledgement information and provided by the physical downlink shared channel, whether to perform contention based transmission.

In another embodiment of the invention, an apparatus comprises means for responding to a contention based physical uplink control channel by sending to at least one user equipment a common physical downlink control channel and a common physical downlink shared channel, wherein the physical downlink shared channel provides acknowledgement/negative acknowledgement information for multiple user equipments.

### BRIEF DESCRIPTION OF THE DRAWINGS

FIG. 1 illustrates a cellular network that may use techniques according to one or more embodiments of the invention;

FIG. 2 illustrates a prior-art signaling diagram;

FIGS. 3-6 illustrate processes according to embodiments of the present invention;

FIG. 7 illustrates elements according to an embodiment of the present invention.

### DETAILED DESCRIPTION

Embodiments of the present invention recognize that one promising application is for the use of a hotspot in an office enterprise, in which a communications area is a large work place. One promising approach for providing local area cellular access over a large workspace is orthogonal frequency division multiple access (OFDMA). Uplink peak to average power ratio (PAPR) is not an important issue in local area networking because transmit power of a UE is nearly equal to that of a base station, implemented in 3GPP and 3GPP-LTE systems as an eNodeB (eNB). In addition, uplink signal to noise ratio (SINR) distribution is similar to downlink SINR distribution. In addition, OFDMA for uplink (UL) in a local area network provides a number of advantages in comparison to single carrier frequency division multiple access (SC-FDMA). These include more flexible resource allocation, uplink and downlink (UL/DL) similarity for device to device communication, similar uplink and downlink structure for interference-aware cancellation design, especially for dynamic time division duplex (TDD) uplink and downlink configuration switching, and the capability of using the same electronic module, such as a radio chip, for both UE and local area network access point (LAN AP) operation.

Embodiments of the present invention address uplink control channel and uplink signaling procedure implementation in order to achieve improved performance in office enterprise environments, and also address UE behaviors directed toward such improved performance.

Uplink transmission methods may be classified as being either contention free or contention based. In contention free uplink transmission, if a UE has uplink data available in a UE logic buffer, it needs to request uplink resources for data transmission.

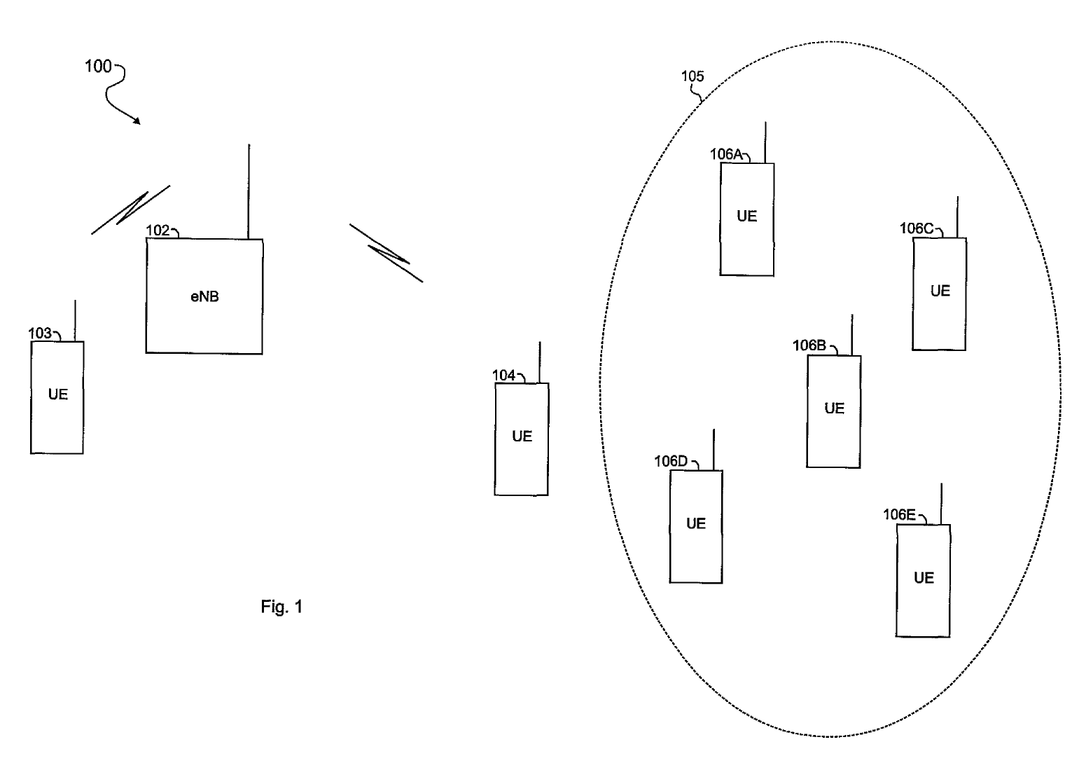

FIG. 1 illustrates a system 100 according to an embodiment of the present invention. The system 100 comprises a base station 100, which may suitably be implemented as an eNodeB (eNB) 102 communicating with a user equipment (UE) 104. The UE 104 serves as an access point for a workspace 105. The workspace 105 comprises wireless networking clients or STAs 106A-106E. The system 100 is configured to use contention-based uplink transmission according to one or more embodiments of the invention.

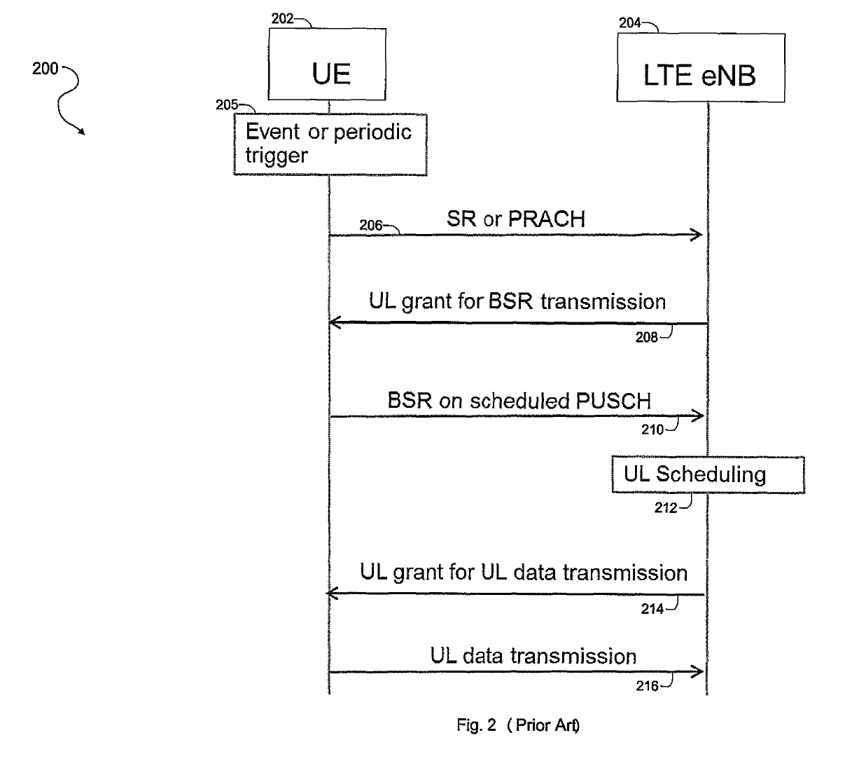

FIG. 2 illustrates a prior-art scheduling procedure 200, between a UE 202 and an LTE eNB 204. Upon the occurrence of an event or periodic trigger 205, the UE 202 may send a scheduling request (SR) 206 by physical uplink control channel (PUCCH) format 1 or physical random access channel for a contention-based uplink resource request if conditions for a scheduling request are fulfilled. The eNB allocates PUSCH resources for sending a buffer status report (BSR) by means of an UL grant 208 to the UE. The UE transmits an indication 210 of the amount of data available in its logic buffer on a scheduled PUSCH to the eNB for UL scheduling 212. After receiving the BSR, the eNB allocates corresponding UL resources by means of a UL grant 214 to the UE for data transmission, taking the uplink radio conditions between the UE and eNB into account. This signaling between UE and eNB is complicated and thus adds latency of data transmission. TDD is the major duplexing technology in local area networking, so that at times UL transmission procedures such as those described above will cause relatively high latency. For example, if DL heavy TDD frame configuration is configured, a procedure such as that described above will require at least 20 ms to obtain UL grant for requested UL transmission. Therefore, embodiments of the present invention provide mechanisms for using contention-based UL transmission. Such contention-based transmission mechanisms can decrease latency because they do not require a scheduling request. The time required for an uplink grant and a buffer status report also becomes unnecessary.

In the current LTE specification, the UL data transmission is controlled by the eNB. The eNB sends an UL grant to identify to the UE the resource to be used and the modulation and coding scheme (MCS) to be used to transmit data. However, for contention based UL data transmission, if no UL grant is sent to the UE, the eNB has no knowledge of the resources and MCS to be used for transmission, and it is difficult for the eNB for detect such information.

Another difficulty is determining HARQ timing for contention based UL data transmission. Fixed timing defined in the current LTE specification is not appropriate for contention-based UL data transmission due to lack of flexibility. In device to device (D2D) communication, for example, transmission and reception might be dynamically scheduled by an eNB. In that case, a D2D UE, for example, cannot make use of fixed timing for acknowledgement/negative acknowledgement A/N transmission.

In addition, in flexible TDD, HARQ timing is complicated and it is impractical to pre-define HARQ timing in advance.

These difficulties, as well as others, are addressed by embodiments of the present invention. One or more embodiments of the invention provide for contention based physical uplink shared channel (PUSCH) transmission along with a physical uplink control channel (PUCCH) transmission. A PUCCH may be transmitted along with contention based PUSCH transmission. An eNB may configure a resource for PUCCH associated with contention based PUSCH. When a UE has data to transmit, it is able to perform contention based PUSCH transmission. A PUCCH may be transmitted simultaneously with the PUSCH. The PUCCH may be configured to carry information relating to the contention based PUSCH. This may include, for example, HARQ process ID, resources, MCS, redundancy version (RV), and other related information. The eNB first decodes the PUCCH and then decodes the contention based PUSCH indicated by the PUCCH.

In one or more embodiments of the invention, A/N corresponding to contention based PUSCH transmission is transmitted on a common PDSCH indicated by a common PDCCH. An eNB sends a common PDCCH scrambled by a new cell-radio network temporary identifier (C-RNTI). The C-RNTI may be on specially configured for the purpose and may, for example, be a HARQ-C-RNTI. All UEs are able to read this PDCCH. This common PDCCH indicates a common PDSCH, and the acknowledgement/negative acknowledgement (A/N) information for all UEs is available in the common PDSCH. For each UE, after obtaining the PDCCH, a UE can find its A/N information in the common PDSCH.

Contention based PUSCH transmission and A/N transmission according to embodiments of the invention provide considerable flexibility. Such mechanisms can support UL asynchronous HARQ and can also be used in conjunction with a number of different communication scenarios, such as device to device (D2D) communication and flexible time division duplex (TDD) UL/DL configuration.

In one or more embodiments of the invention, a physical uplink control channel is used to carry information to support contention based PUSCH transmission. The resource of this PUCCH channel can be semi-statically configured to each UE, such as the UE 104. Configuration may be accomplished, for example, using radio resource control (RRC) signalling. It will be recognized that the use of RRC signalling is exemplary, and that other examples of signaling that may be used for configuration include higher layer signaling or L1 signaling.

The PUCCH can carry information associated with contention based PUSCH. This information may include, for example, a UL HARQ process ID corresponding to PUSCH, identification of the resources used by PUSCH, the modulation and coding scheme used by PUSCH, redundancy version, and the like. The PUCCH may be CRC scrambled by C-RNTI.

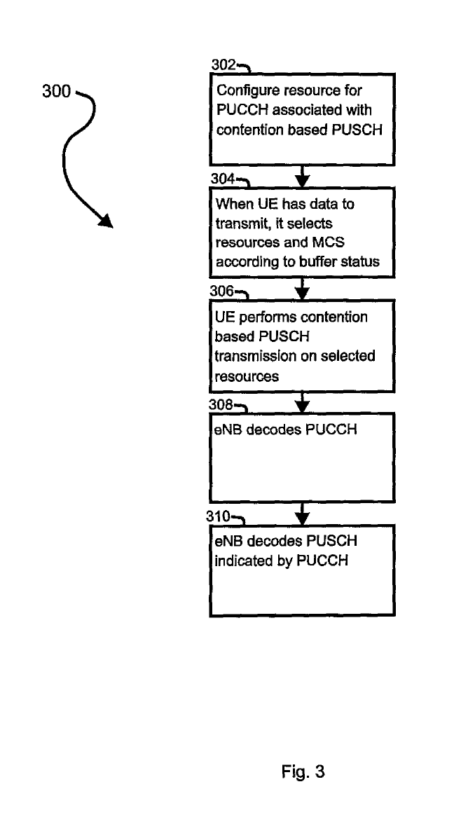

FIG. 3 illustrates a process 300 of contention based PUSCH transmission according to an embodiment of the present invention. At step 302, a resource is configured for a PUCCH associated with contention based PUSCH, suitably using radio resource control signaling. A PUCCH may be configured for each UE, such as the UE 104 of FIG. 1. At step 304, when a UE has data to transmit, it selects resources and MCS according to its buffer status. Information for the selection is carried by the PUCCH. At step 306, the UE performs contention based PUSCH transmission on the selected resources. At step 308 the eNB decodes the PUCCH. At step 310, the eNB decodes the PUSCH indicated by the PUCCH.

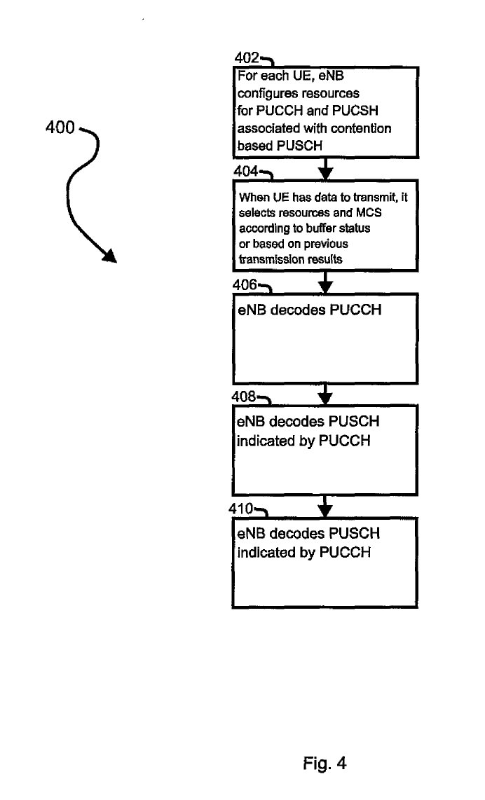

In order to reduce the collision of contention based PUSCH transmission between UEs, the eNB can, specifically for each UE, configure the resources for contention based PUSCH transmission. The resource for contention based PUSCH is restricted and different UEs can be configured for different resources, while the resources can be overlapped. FIG. 4 therefore illustrates a process 400 according to another embodiment of the present invention. At step 402, an eNB configures a resource for PUCCH associated with contention based PUSCH, suitably for each UE and suitably using RRC signalling. The eNB configures the resources for contention based PUSCH for each UE. At step 404, when the UE has data to transmit, it selects resources among the configured resources from eNB and MCS according to its buffer status or, alternatively, based on previous transmission results, such as a successful contention based PUSCH transmission ratio. This information may be available from the PUCCH. The UE can perform contention based PUSCH transmission on the selected resources. At step 406, the eNB decodes PUCCH, and then at step 408, the eNB decodes the PUSCH indicated by the PUCCH.

One or more embodiments of the invention define the use of A/N information do determine whether transmission corresponding to contention based PUSCH is to be performed. A common PDCCH, such as a PDCCH scrambled by specifically chosen C-RNTI can be defined, such as a HARQ-C-RNTI. The common PDCCH indicates one common PDSCH. A/N corresponding to contention based PUSCH transmission is transmitted on the common PDSCH. All the UEs can read the common PDCCH and a UE finds its own A/N on the common PDSCH accordingly.

The common PDCCH can identify the HARQ process ID, the resources used and MCS adopted by the common PDSCH and the format of the control header in the common PDSCH. In the format of a control header, the PDCCH can indicate the bits of control information for each UE in the control header. The following table shows one example of control header format. In this case, 2 bits are sufficient in the PDCCH to indicate the control header format.

| Control Header | Bits to indicate | | A/N payload |
|---|---|---|---|
| Format | Number of UE | C-RNTI (bits) | information (bits) |
| Format 1 | 0 | 16 | 10 |
| Format 2 | 1 | 16 | 10 |
| Format 3 | 2 | 16 | 20 |
| Format 4 | 3 | 16 | 20 |

One example of common PDCCH is illustrated below:

| Field | Bit(s) |
|---|---|
| Resource block assignment | Ceiling(N_{RB}/P) |
| MCS | 5 |
| Control header format | 2 |

Another example of common PDCCH is illustrated below:

| Field | Bit(s) |
|---|---|
| HARQ process ID | 3 |
| Resource block assignment | Ceiling(N_{RB}/P) |
| MCS | 5 |
| Control header format | 2 |

The common PDSCH may, for example, contain the following information:
Control header
   Number of UEs (this information can be interpreted by UEs to provide an indication of the control header length)
   C-RNTI (UE ID), which identifies which UE's A/N is contained in the common PDSCH
   A/N payload information: where to read the A/N information and how much A/N information (length) is contained.
(From information provided in the control header, a UE can determine whether its A/N is transmitted in the common PDSCH and, if its A/N information is present, where to find its information in the common PDSCH.) A/N payload
   UL HARQ process ID: corresponding to which contention based PUSCH transmission
   A/N

The following table shows an example of common PDSCH comprising A/N information for 2 UEs. The information can be easily extended to more UEs. In this example, it is assumed that control header format 2 is adopted. The UE can derive that the total bits for control header is 1+2*(16+10)=53 bits, while the left of PDSCH contains A/N information. A UE can find its A/N information from the control header. For A/N transmission, a UE can transmit the corresponding UL HARQ process ID along with A/N simultaneously.

| | | | | |
|---|---|---|---|---|
| Number of | UE1: C-RNTI, | UE2: C-RNTI, | UE1: UL | UE2: UL |
| UE | UE1 Payload | UE2 Payload | HARQ | HARQ |
| | information | information | process | process |
| | | | ID + A/N | ID + A/N |

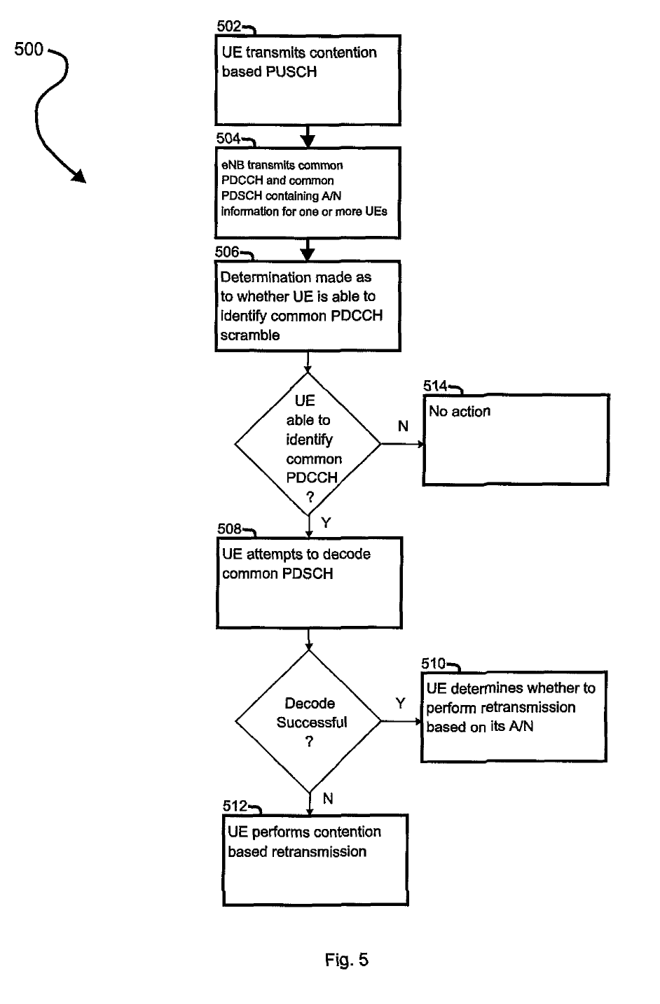

FIG. 5 illustrates a process 500 of A/N transmission for contention based PUSCH according to an embodiment of the present invention. At step 502, a UE transmits a contention based PUSCH. At step 504, an eNB transmits a common PDCCH and common PDSCH containing A/N information. The PDSCH may contain information for multiple UEs. The process proceeds to step 506, and, for each UE, a determination is made as to whether the UE is able to identify the common PDCCH scramble through the use of an identifier, such as the HARQ-C-RNTI. If the UE is able to identify the PDCCH scramble, the process proceeds to step 508 and an attempt is made to decode the common PDSCH. If the common PDSCH is decoded successfully, the UE has access to its information contained in the PDSCH, such as its A/N information. The process proceeds to step 510 and the UE determines whether to perform retransmission based on the A/N information. If the common PDSCH is not decoded successfully, the process proceeds to step 512. At step 512, the UE performs contention based retransmission.

Returning now to step 506, for each UE that is unable to identify the PDDCH scramble, the process proceeds to step 514 and no action is taken by the UE.

A small but finite probability exists that a common PDDCH will be unreadable or otherwise unavailable. Over a wide area, the probability of unavailability of the PDDCH is approximately 1%, and in a local area exhibiting good channel quality, the probability of unavailability of the PDCCH can be much less than 1%.

To deal with the case in which common PDDCH is unavailable, one or more embodiments of the present invention define a timer. For example, the eNB can configure a timer for each UE, and the UE may be configured to wait for the common PDCCH to become available during the validity of the timer. If the PDDCH becomes available while the timer is valid, the UE decodes the PDCCH and performs retransmission based on the A/N information provided by the PDCCH. If the timer expires, the UE performs contention based retransmission.

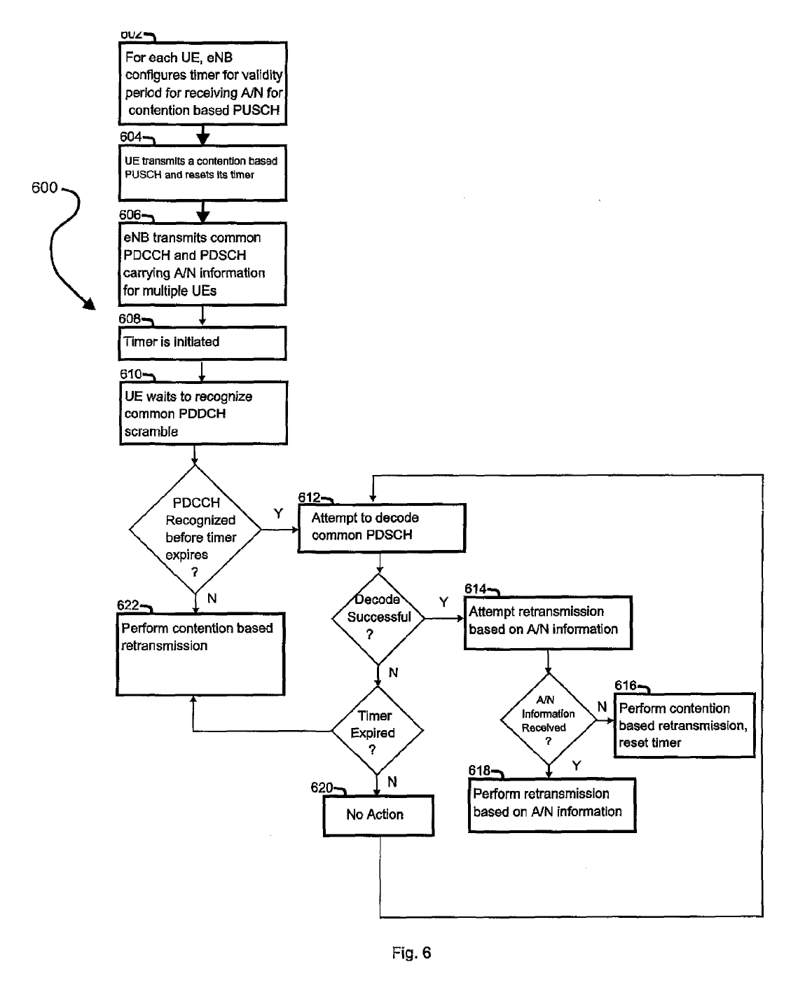

FIG. 6 illustrates a process 600 according to an embodiment of the present invention, in which a timer is configured to address a failure of availability of the PDCCH. At step 602, an eNB configures, for each UE, a timer defining a validity period for receiving A/N for a contention based PUSCH. At step 604, a UE transmits a contention based PUSCH and resets its timer. At step 606, the eNB transmits a common PDCCH and common PDSCH carrying A/N information for multiple UEs. For each UE, the process proceeds to step 508 and the timer is initiated. At step 610, during the validity of its timer, the UE waits to recognize the common PDDCH scramble. Recognition may be accomplished, for example, by recognizing the HARQ-C-RNTI. At step 612, upon recognition of the PDCCH, an attempt is made to decode the common PDSCH. If the common PDSCH is decoded successfully, the process proceeds to step 614 and the UE attempts retransmission based on the A/N information provided by the PDSCH. If no A/N is received during the timer validation, the process proceeds to step 616 and the UE performs contention based retransmission and resets the timer. If A/N information is received, the process proceeds to step 618 and retransmission based on A/N is performed. If the PDCCH is not decoded and the timer has not expired, the process proceeds to step 620 and no action is taken. The process then returns to step 612.

If the timer expires without recognition of the PDCCH, the process proceeds to step 622, and the UE performs contention based retransmission.

The use of A/N information as described above with respect to FIGS. 5 and 6 provides considerable flexibility and is able to support UL asynchronous HARQ and flexible TDD configuration. Such mechanisms can also be extended to D2D communication. Examples of D2D communication that may be used include D2D communication, in which a single UE communicates with another UE, and D2D multicast communication, in which a single UE broadcasts to multiple UEs. For D2D communication (one UE to one UE), the control header may not be needed. In that case, one control header format can be added (format 1 in the following table). The PDSCH need contain only A/N information.

D2D multicast communication may be looked on as being analogous to a cellular system. In such a system, all formats described above can be used.

The following table presents one example of control header format for D2D communication. For both of the two kind of D2D communication, the communication and the providing of information using the PDDCH, as described above, can be used.

| Control Header | Bits to indicate | | A/N payload |
|---|---|---|---|
| Format | Number of UE | C-RNTI (bits) | information (bits) |
| Format 1 | 0 | 0 | 0 |
| Format 2 | 1 | 16 | 10 |
| Format 3 | 2 | 16 | 20 |
| Format 4 | 2 | 16 | 30 |

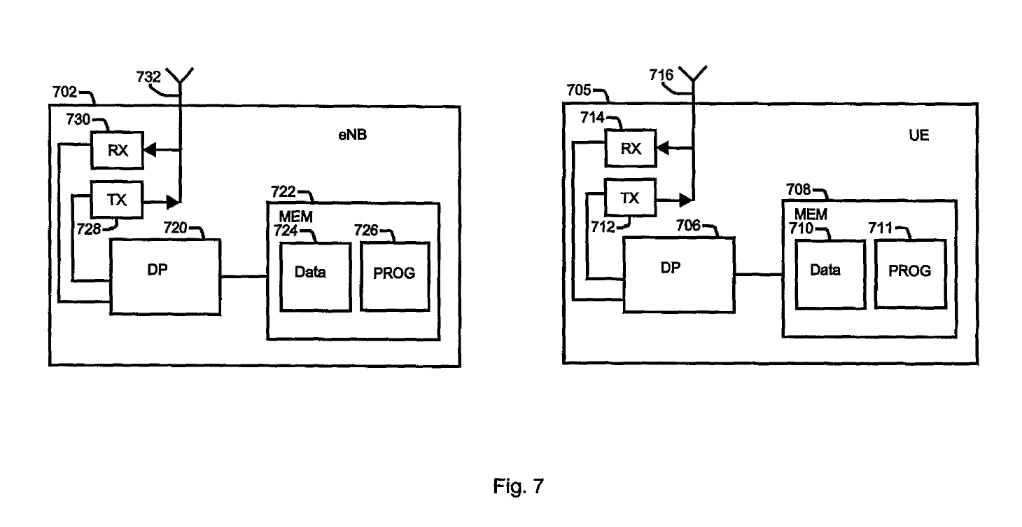

Reference is now made to FIG. 7 for illustrating a simplified block diagram of various electronic devices and apparatus that are suitable for use in practicing the exemplary embodiments of this invention. In FIG. 7 an eNB 702 is adapted for communication over a wireless link 704 with an apparatus, such as a mobile device/terminal such as a UE 705. While there are typically several UEs under control of an eNB such as the eNB 702, for simplicity only one UE 705 is shown at FIG. 7. The UE 704 may be a user device similar to the devices 104A and 104B of FIG. 1, and a UE and eNB are illustrated here because one convenient mechanism for carrying out embodiments of the present invention involves communication using a cellular communication network. The eNB 702 may be any access node (including frequency selective repeaters) of any wireless network such as LTE, LTE-A, GSM, GERAN, WCDMA, and the like.

The UE 705 includes processing means such as at least one data processor (DP) 706, storing means such as at least one computer-readable memory (MEM) 708 storing data 710, at least one computer program (FROG) 711 or other set of executable instructions, communicating means such as a transmitter TX 712 and a receiver RX 714 for bidirectional wireless communications with the eNB 702 via one or more antennas 716.

The eNB 702 also includes processing means such as at least one data processor (DP) 720, storing means such as at least one computer-readable memory (MEM) 722 storing data 724 and at least one computer program (FROG) 726 or other set of executable instructions. The eNB 702 may also include and communicating means such as a transmitter TX 728 and a receiver RX 730 for bidirectional wireless communications with the UE 705 (or UEs) via one or more antennas 732.

At least one of the PROGs 712 in the eNB 702 is assumed to include a set of program instructions that, when executed by the associated DP 720, enable the device to operate in accordance with the exemplary embodiments of this invention, as detailed above. The UE 705 also stores software 726 in its MEM 708 to implement certain aspects of these teachings. In these regards the exemplary embodiments of this invention may be implemented at least in part by computer software stored on the MEM 708 and 722, which is executable by the DP 706 of the UE 705 and/or by the DP 720 of the eNB 705, or by hardware, or by a combination of tangibly stored software and hardware (and tangibly stored firmware). Electronic devices implementing these aspects of the invention need not be the entire devices as depicted at FIG. 3 or may be one or more components of same such as the above described tangibly stored software, hardware, firmware and DP, or a system on a chip SOC or an application specific integrated circuit ASIC.

In general, the various embodiments of the UE 705 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 708 and 722 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 706 and 720 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1-55. (canceled)

56. An apparatus comprising:
at least one processor;
memory storing computer program code;
wherein the computer program code is configured to, with the memory and the at least one processor, cause the apparatus to at least:
perform contention based transmission using a physical uplink shared channel, based at least in part on information provided by a physical uplink control channel associated with the physical uplink shared channel.

57. The apparatus of claim 56, wherein the physical uplink control channel is configured by a base station through signaling.

58. The apparatus of claim 56, wherein the physical uplink control channel comprises at least one of a hybrid automatic repeat request process identifier, resources used by the physical uplink shared channel, a modulation and coding scheme adopted by the physical uplink shared channel, and redundancy version.

59. The apparatus of claim 56, wherein the physical uplink control channel is cyclic redundancy check scrambled by cell-radio network temporary identifier.

60. The apparatus of claim 56, wherein at least one resource for the physical uplink shared channel is restricted and may be configured by network.

61. The apparatus of claim 56, wherein the apparatus is configured to use a specified resource for contention based physical uplink shared channel transmission, and wherein each of a plurality of different resources may be configured for use by different devices.

62. The apparatus of claim 56, wherein resources available for contention based physical uplink shared channel transmission overlap.

63. The apparatus of claim 56, wherein the physical uplink control channel is transmitted simultaneously with the physical uplink shared channel.

64. An apparatus comprising:
at least one processor;
memory storing computer program code;
wherein the computer program code is configured to, with the memory and the at least one processor, cause the apparatus to at least:
attempt to decode a physical downlink shared channel to obtain acknowledgement/negative acknowledgement information associated with the apparatus, wherein information relating to the physical downlink shared channel is available in a common physical downlink control channel; and
upon successful decoding, determine, based at least in part on acknowledgement/negative acknowledgement information associated with the apparatus and provided by the physical downlink shared channel, whether to perform contention based transmission.

65. The apparatus of claim 64, wherein the apparatus configures for transmission a contention based physical uplink shared channel and the physical downlink control channel is received in response to the physical uplink shared channel.

66. The apparatus of claim 64, wherein the physical downlink control channel is a common physical downlink control channel indicating a single common physical downlink shared channel.

67. The apparatus of claim 64, wherein the apparatus sets a timer and wherein the apparatus directs contention based retransmission on expiration of the timer without decoding of the physical downlink control channel.

68. A method comprising:
performing contention based transmission using a physical uplink shared channel, based at least in part on information provided by a physical uplink control channel associated with the physical uplink shared channel.

69. The method of claim 68, wherein the physical uplink control channel is configured by a base station through signaling.

70. The method of claim 68, wherein the physical uplink control channel comprises at least one of a hybrid automatic repeat request process identifier, resources used by the physical uplink shared channel, modulation and coding scheme adopted by the physical uplink shared channel, and redundancy version.

71. The method of claim 68, wherein the physical uplink control channel is cyclic redundancy check scrambled by cell-radio network temporary identifier.

72. The method of claim 68, wherein at least one resource for physical uplink shared channel transmission is restricted and may be configured by the network.

73. The method of claim 68, wherein a specified resource is used for contention based physical uplink shared channel transmission, and wherein each of a plurality of different resources may be configured for use by different devices.

74. The method of claim 68, wherein resources available for contention based physical uplink shared channel transmission overlap.

75. The method of claim 68, wherein the physical uplink control channel is transmitted simultaneously with the physical uplink shared channel.
